(19) United States
(12) Patent Application Publication
(10) Pub. No.: US 2009/0230632 A1
(43) Pub. Date: Sep. 17, 2009

(54) SYSTEM, METHOD AND APPARATUS FOR SEALING MATERIALS HAVING A LOW GLASS TRANSITION TEMPERATURE FOR HIGH PERFORMANCE SEALING APPLICATIONS

(75) Inventors: Donald R. Petrash, Highlands, TX (US); Steven C. Ellis, The Woodlands, TX (US)

Correspondence Address: Patent Department;GE Oil & Gas, 4424 West Sam Houston Parkway North, Suite 100, Houston, TX, 77041, US

(73) Assignee: VETCO GRAY INC., Houston, TX (US)

(21) Appl. No.: 12/396,769

(22) Filed: Mar. 3, 2009

Related U.S. Application Data
(60) Provisional application No. 61/036,097, filed on Mar. 13, 2008.

(51) Int. Cl. F16J 15/18; B29C 65/00; B82B 1/00

(52) U.S. Cl. 277/584; 264/259; 977/750; 977/752

(57) ABSTRACT

A seal is formed from one or more elastomeric materials having a low glass transition temperature for high pressure, and both high and low temperature sealing applications. In an exemplary embodiment, the glass transition temperature (Tg) of the material may be −35° C. or lower. The seal is adapted to repeatedly form and maintain a seal across a temperature range from 0° C. or lower to +122° C. or greater at pressures up to 15,000 p.s.i.g. or greater. The invention has numerous applications, such as for land-based use, marine surface and marine subsea uses. An anti-extrusion device may circumscribe the upper and lower edges of the material body. The invention also comprises fabrication methods for elastomer or polymeric seals.

This application claims priority to and the benefit of U.S. Provisional Patent Application No. 61/036,097, filed Mar. 13, 2008, which is incorporated herein by reference in its entirety.

### BACKGROUND OF THE INVENTION

1. Technical Field

The present invention relates in general to sealing applications for high performance environments and, in particular, to an improved system, method, and apparatus for an elastomeric or polymeric material having a low glass transition temperature (Tg) for high pressure, and both high and low temperature sealing applications.

2. Description of the Related Art

The equipment used in oil and gas exploration applications must perform under extreme operating conditions. In particular, the seals used between the various types of components may be used for static or dynamic operations and have flexible elements that are subjected to harsh temperatures and pressures. Most flexible materials, such as polymers and elastomers, are only capable of operating in relatively conventional temperature and pressure ranges. For example, typical operating temperatures are in the range of 0° C. to +121° C., and pressures are less than or equal to 10,000 psi. However, the demands for new oil and gas production is driving exploration into fields having temperature and pressure conditions outside the conventional temperature and pressure ranges.

Although existing materials are workable for some applications, an improved system, method and apparatus for seals in high performance environments would be desirable.

### SUMMARY OF THE INVENTION

Embodiments of a system, method, and apparatus for an elastomeric material having a low glass transition temperature (Tg) for high pressure, and both high and low temperature sealing applications are disclosed. In some embodiments, the invention has a Tg of −35° C. or below.

The material performs well at extreme temperature ranges at both the upper and lower ends of the spectrum. For example, in operation the elastomeric material seals repeatedly at temperatures above +121° C., and below 0° C. at pressures above 10,000 p.s.i.g. In an exemplary embodiment, the temperature range for repeated sealing extends from a temperature less than or equal to −18° C. to a temperature greater than or equal to +149° C. at a pressure up to 15,000 p.s.i.g. of more. The invention has numerous applications, such as for land-based use, marine surface and marine subsea uses. An anti-extrusion device may circumscribe the upper and lower edges of the material body, and/or bonded to metal end rings. The invention also comprises fabrication methods for elastomer or polymeric seals.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1 is a block diagram of a method for manufacturing a seal material operable to maintain a seal repeatedly at high pressures and high temperature, as well as high pressures and low temperatures, in accordance with an exemplary embodiment of the present technique;

FIG. 2 is a schematic diagram of embodiments of operational pressure and temperature ranges for applications of the invention, in accordance with an exemplary embodiment of the present technique;

FIG. 3 is a sectional side view of one embodiment of a seal constructed in accordance with the invention, in accordance with an exemplary embodiment of the present technique;

FIG. 4 is a sectional side view of an embodiment of a seal application in accordance with the invention, in accordance with an exemplary embodiment of the present technique; and

FIG. 5 is a sectional side view of an alternative embodiment of a seal application in accordance with an exemplary embodiment of the present technique.

### DETAILED DESCRIPTION OF THE INVENTION

Embodiments of a system, method and apparatus for an elastomer or polymeric material having a low glass transition temperature (Tg) for high pressure, high temperature (HPHT), and high pressure, low temperature (HPLT) sealing applications are disclosed.

The glass transition temperature (Tg) is the temperature at which an amorphous solid, such as a glass or a polymer, becomes brittle on cooling or soft on heating. A brittle polymeric seal is less effective as a seal than a ductile elastomeric or polymeric seal. Therefore, a seal should be operated at temperatures above its glass transition temperature (Tg).

The glass transition temperature (Tg) of a material may be affected by pressure. For example, an increase in the pressure on a material typically shifts the glass transition temperature (Tg) of the material upward to a higher temperature. In the case of a seal exposed to high pressures, such as 10,000 p.s.i.g. or more, the shift in the glass transition temperature (Tg) may be significant. In operation, the shift to a higher glass transition temperature (Tg) due to a higher pressure may drive the glass transition temperature (Tg) of a seal material to a temperature above the ambient temperature of the seal, reducing the ability of the seal material to form and maintain a seal. By using a material with a lower initial glass transition temperature (Tg), a seal may be produced that forms and maintains a seal at a lower temperature for a given high pressure application.

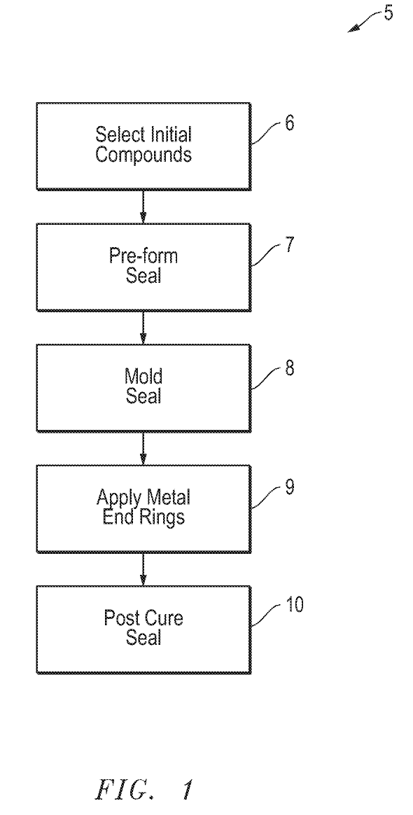

Referring generally to FIG. 1, a method of manufacturing a seal operable to form and maintain a seal repeatedly at high pressure and low temperature conditions, as well as high pressure and high temperature conditions is presented, and represented generally by reference numeral 5. In this embodiment, the desired operating pressure for the seal exceeds 10,000 p.s.i.g. and the desired operating temperatures extends from below 0° C. to above 121° C. For example, the techniques described herein enable a seal to be produced that forms and maintains a seal repeatedly at a pressure of up to or exceeding 15,000 p.s.i.g. and over a temperature range from −18° C. to 149° C. The techniques may enable seals to be produced that are operable over even greater pressure and temperature ranges.

In the illustrated embodiment, the method of manufacturing a seal comprises selecting an initial elastomeric/polymeric compound that will be operable to produce a seal that is operable to form and maintain a seal repeatedly at the desired pressures and temperatures after the manufacturing process is complete, as represented by block 6.

In an exemplary embodiment, the initial compound may comprise a compound based on hydrogenated nitrile elastomers, such as hydrogenated acrylonitrile-butadiene (XNBR), suitably compounded, with a glass transition temperature of −35° C. or below. However, in other embodiments, the material may comprise other polymeric material compounds with a Tg of −35° C. or below, and which are suitable for the types of applications described herein.

In other embodiments, the polymeric materials used to form the parts may comprise acrylonitrile-butadiene (NBR), carboxylic-acrylonitrile-butadiene (XNBR), carboxylic-hydrogenated acrylonitrile-butadiene (XHNBR), copolymers of ethylene and polypropylene (EPM), terpolymer of ethylene, propylene and diene with a residual unsaturated portion of the diene in the side chain (EPDM), a fluorocarbon family of FKM, FEPM and FFKM, combinations and blends of any these polymers to achieve a low Tg, the addition of nanotechnology-enhanced polymer materials (e.g., single-walled carbon nanotubes (swcnt), multi-walled carbon nanotubes (mwcnt), etc.) to these materials, and the replacement of at least a portion of the carbon black used in flexible materials being formed with such nanotechnology-enhanced polymer materials. In addition, peroxides are added to the elastomeric compound. The peroxides cross-link with the elastomers to produce the desired physical properties. However, a material other than a peroxide may be used for cross-linking, such as sulphur or a sulphur-based compound.

In addition, the lower glass transition temperature (Tg) of the exemplary embodiment is not produced through the use of a plasticizer. However, a plasticizer may be added to the initial compound for reasons other than lowering the glass transition temperature (Tg), such as by aiding mixing during the manufacturing process. Plasticizers may burn off at high temperatures. Therefore, if a plasticizer were used to lower the glass transition temperature (Tg), the glass transition temperature (Tg) of the compound would be raised after the plasticizer was burned off As a result, the seal may not be able to form and maintain a seal if it was returned to a lower temperature. Thereby, removing the ability of the seal to repeatedly form and maintain a seal over the desired pressure and temperature ranges.

Pre-forming operations are performed on the compound prior to molding, as represented by block 7. The compound may be warmed on a rubber mill and extruded to produce a desired profile. The extruded profile may them be cut to a desired length to fit in the mold. In an exemplary embodiment, the ends of the extruded length of seal are cut with a 45° skive cut so that the ends overlap when formed into a ring. Alternatively, the elastomer may be cut to fit the mold, such as in a donut-shape. In addition, the weight of the pre-form seal material is weighed to ensure proper fill of the mold.

The compound is then pressure molded to form an elastomeric seal, as represented by block 8. The preformed seal is disposed within a mold. In the exemplary embodiment, the compound is warmed to a molding temperature and pressure molded. In an exemplary embodiment, the molding temperature may be approximately 149° C. In addition, at least two pressure increases or “bumps” may be applied to the elastomer to degas the mold.

The compound is then cured at an appropriate temperature to develop the desired physical properties. The cure temperature increases cross-linking between the elastomer and the cross-linking compounds. In an exemplary embodiment, the curing temperature increases cross-linking between the HNBR and the peroxides. In addition, in an exemplary embodiment, the seal is cured at a minimum of 160° C. for ten to fifteen minutes. After molding, the flash around the elastomer is removed. The elastomer may be inspected for defects and its dimensions verified.

In the illustrated embodiment, metal end rings are applied to the elastomeric seal, as represented by block 9. In the illustrated embodiment, the end rings are cleaned and a rubber adhesive primer, such as Chemlock® primer, is applied to the inside of each metal end ring. After drying, a rubber adhesive, such as Chemlock® rubber adhesive, is applied over the rubber adhesive primer. In this embodiment, the region of the seal that is to come into contact with the metal end rings is prepared for bonding. The end rings are assembled onto the elastomeric seal placed into a hot press. Spacer blocks are added to maintain the shape of the elastomer when pressure is applied. Alternatively, the seal may be cured in an oven.

Additional, post-curing processes are then performed on the seal, as represented by block 10. The elastomeric and metal end rings are heated to a post-cure temperature of at least 160° C. for an appropriate period of time. The post-cure heating produces additional cross-linking within the elastomer, such as HNBR, of the seal and to improve bonding of the elastomer with the metal end rings. The specific period of time of the post-cure heating may be based on laboratory tests. In an exemplary embodiment, the post-cure heating time may be between eight to twelve hours. The seal may then be cooled, trimmed, and inspected. The inspection may include an inspection of the bond between the elastomer and the end rings and to verify that the elastomer is adequately filled within the end rings. In addition, the outer diameter, the inner diameter, and the height of the seal may be checked. In an exemplary embodiment, the elastomeric material of the seal is bonded to the OD of the metal end rings.

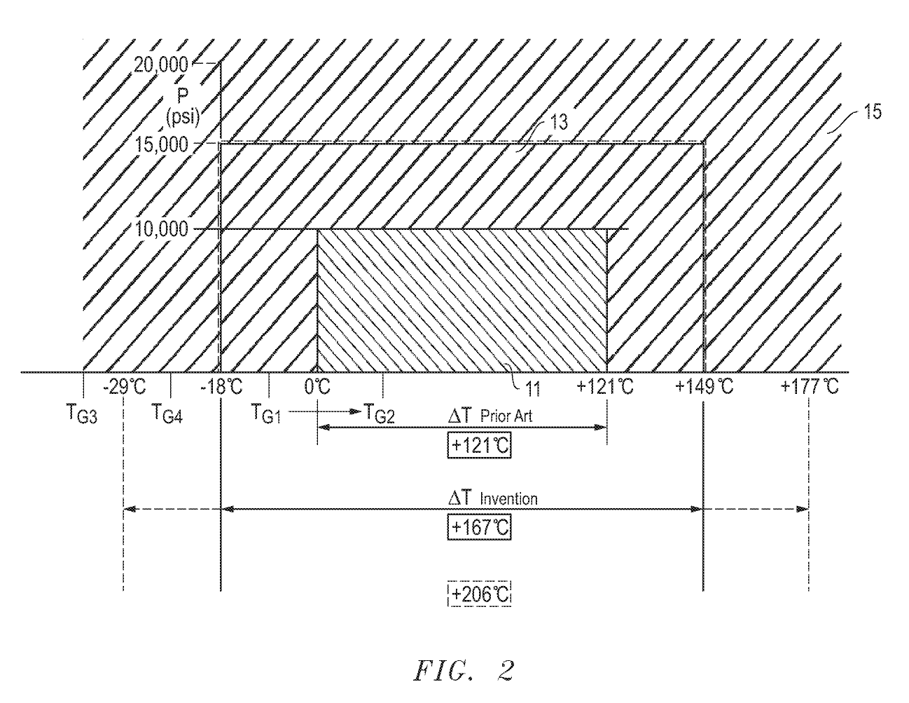

Referring generally to FIG. 2, the environment in which the material is used for sealing applications may comprise extreme temperature ranges at both the upper and lower ends of the spectrum. The operating ranges for conventional seals used in the oil and gas industry is represented by region 11 of FIG. 2. The maximum pressure of the range for a conventional seal is 10,000 p.s.i.g. The temperature range extends from 0° C. to 121° C. However, a seal manufactured using the techniques described above may repeatedly form and maintain a seal at pressures and temperatures outside the range for conventional seals. In one embodiment, a seal manufactured using the techniques described above may repeatedly form and maintain a seal at temperatures extending from a temperature of −18° C. (or lower) to a temperature of +149° C. (or higher) at pressures up to of 15,000 p.s.i.g., as shown in region 13 of FIG. 2.

In other embodiments, a seal manufactured using the techniques described above may operate over an even greater range of pressure and temperature. For example, a seal manufactured using these techniques may repeatedly form and maintain a seal at temperatures extending from a temperature of −29° C. to a temperature of 177° C. at pressures over 20,000 p.s.i.g., as shown in region 15 of FIG. 2.

As discussed above, the glass transition temperature (Tg) of a material may be affected by pressure. For example, an increase in pressure on a material typically shifts the glass transition temperature (Tg) of the material upward to a higher temperature. In the case of a seal exposed to high pressures, such as pressures exceeding 10,000 p.s.i.g., the shift in the glass transition temperature (Tg) may be significant. The shift to a higher glass transition temperature (Tg) due to a higher pressure may drive the glass transition temperature (Tg) of a seal material to a temperature above the actual temperature of the seal, reducing the ability of the seal material to form and hold a seal.

For example, a conventional seal may have a glass transition temperature (Tg1) near 0° C. However, if the pressure on the seal is increased to 15,000 p.s.i.g., the glass transition temperature is shifted upward to a new glass transition temperature (Tg2). Therefore, if the seal is exposed to a temperature within the operating range, but below the new glass transition temperature (Tg2) of the seal, the seal may be too brittle to form a proper seal. For example, in the illustrated embodiment, a conventional seal exposed to a pressure of 15,000 p.s.i.g. may be too brittle to form a seal if the seal temperature were 0° C.

However, a seal produced using the techniques described above that utilizes a seal material with a lower glass transition temperature (Tg) and without the use of plasticizers may seal effectively over a larger range of pressure an temperature conditions. In an exemplary embodiment, the seal manufactured using the techniques described above has a glass transition temperature (Tg3) of no greater then −35° C. An increase in pressure causes the seal to shift upward to a new glass transition temperature (Tg4). The new glass transition temperature (Tg4) enables the seal to operate at much higher pressures at low temperatures.

For example, a seal manufactured using the techniques described above enable the seal to form and maintain a seal repeatedly at a temperature of −18° C. when the pressure is up to 15,000 p.s.i.g. In addition, because no plasticizers are present that may burn off at high temperatures a seal manufactured using the techniques described above enable the seal to form and maintain a seal repeatedly at a temperature of 149° C. when the pressure is up to 15,000 p.s.i.g.

The invention is particularly well suited for custom molded parts for API, ISO and other service applications. This material is compatible with sweet and sour gas and/or crude oil, with or without carbon dioxide, brine and corrosion inhibitors. In the exemplary embodiment, the material has a hardness of 85±5 Shore “A” that is cross-linked with peroxides, a minimum tensile strength of 1800 psi, and a minimum ultimate elongation of 100%. The material also has a minimum tensile stress of 800 psi at 50% E, and 1500 psi at 100% E.

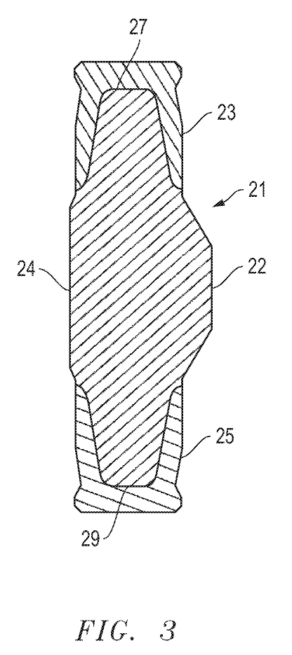

The invention has numerous applications, such as for land-based use, marine surface and marine subsea uses. For example, as shown in FIG. 3 (sectional view), the seal may be formed in a continuous cylindrical shape having a flexible body 21 comprising the elastomeric or polymeric materials described herein. An anti-extrusion device, such as upper and lower end caps 23, 25 (e.g., formed from metallic and/or polymeric materials), completely circumscribe the upper and lower edges 27, 29, respectively, of body 21. In the embodiment shown, the body 21 has an inner seal portion 22 and an opposite outer seal portion 24. Inner seal portion 22 energizes the seal to seal both itself and the outer seal portion 24. However, the invention is readily adaptable to seal against inner surfaces, and may comprise many other types of shapes and configurations (e.g., o-ring, polypak, etc.) depending on the application.

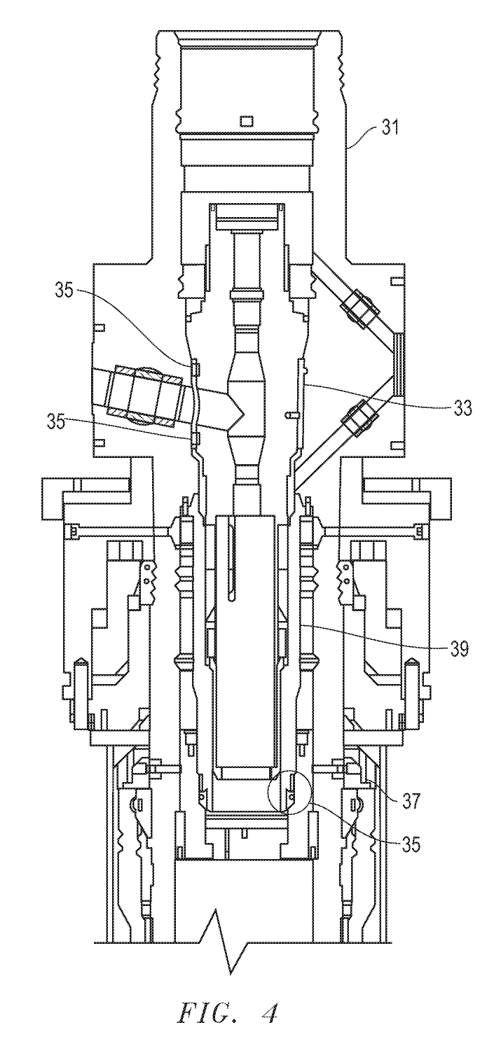

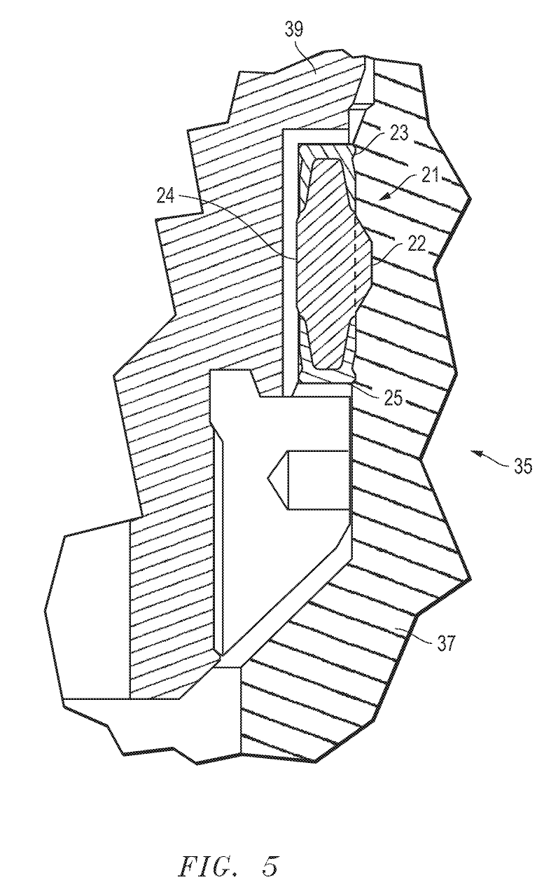

For example, as shown in FIGS. 4 and 5, one type of application includes the use of a material in accordance with the invention. In this embodiment, a well bore having a tree head assembly 31 and a tubing hanger 33 uses a seal 35 as described herein. The seal 35 may be used to seal between a casing hanger 37 and an isolation sleeve 39 that are located below the tubing hanger 33. Additional seals 35 may be used directly between the tree head assembly 31 and tubing hanger 33.

The invention also comprises fabrication methods for elastomer or polymeric seals having a very low Tg for use in HPHT and HPLT environments. The material may comprise HNBR or other compounds as described herein for use in high pressure and high or low temperature applications.

While the invention has been shown or described in only some of its forms, it should be apparent to those skilled in the art that it is not so limited, but is susceptible to various changes without departing from the scope of the invention.

We claim:

1. A method of fabricating an elastomeric seal, comprising:
providing a elastomeric material having a Tg of −35° C. or lower to achieve a low operating temperature (T<0° C.) sealing at high pressure (P>10,000 psi);
filling or laying-up of an elastomer preform in a mold with the elastomeric material;
overlapping the elastomer preform;
curing the elastomer preform for vulcanization and cross-linking to obtain required physical properties to form an elastomer part; and then
bonding metal or elastomeric end rings to the elastomer part, and filling end ring voids in a mold with the elastomer part.

2. The method as recited in claim 1, wherein the seal is cured at a temperature in a range of +160° C. or higher to improve crosslink density and physical properties of the seal, and curing at this temperature requires complete filling of the mold during fabrication of the elastomeric part.

3. The method as recited in claim 1, wherein the elastomer preform is continuous cylindrical shape.

4. A seal, comprising:
a elastomeric material having a low glass transition temperature (Tg) of at least −35° C. for high pressure, high temperature and low temperature sealing applications; and
an anti-extrusion device mounted to the elastomeric material.

5. A seal according to claim 4, wherein a high temperature operating range for the seal is no lower than +122° C., and a low temperature operating range is no greater than 0° C.

6. A seal according to claim 5, wherein the high temperature operating range is at least +149° C., and the low temperature operating range is at least −18° C.

7. A seal according to claim 5, wherein the high temperature operating range is at least +177° C., and the low temperature operating range is at least −29° C.

8. A seal according to claim 4, wherein a high pressure operating range for the seal is no less than 10,000 psi.

9. A seal according to claim 4, wherein a high pressure operating range for the seal is no less than 15,000 psi.

10. A seal according to claim 4, wherein a high pressure operating range for the seal is no less than 20,000 psi.

11. A seal according to claim 4, wherein the elastomeric material is selected from the group consisting of hydrogenated acrylonitrile-butadiene (HNBR), acrylonitrile-butadiene (NBR), carboxylic-acrylonitrile-butadiene (XNBR), carboxylic-hydrogenated acrylonitrile-butadiene (XHNBR), copolymers of ethylene and polypropylene (EPM), terpolymer of ethylene, propylene and diene with a residual unsaturated portion of the diene in a side chain (EPDM), a fluorocarbon family of FKM, FEPM and FFKM, and combinations and blends of any these polymers to achieve a low Tg.

12. A seal according to claim 11, wherein the elastomeric material further comprises a nanotechnology-enhanced polymer material comprising swcnt or mwcnt.

13. A seal according to claim 12, wherein the elastomeric material further comprises carbon black, and at least a portion of the carbon black used in fabricating the seal is replaced with the nanotechnology-enhanced polymer material.

14. A seal according to claim 4, wherein the elastomeric material has a hardness of 85±5 Shore “A” that is cross-linked with peroxides, a minimum tensile strength of 1800 psi, a minimum ultimate elongation of 100%, a minimum tensile stress of 800 psi at 50% E, and 1500 psi at 100% E.

15. A seal according to claim 4, wherein the seal is formed in a continuous cylindrical shape with a flexible body formed from the elastomeric material, and the anti-extrusion device completely circumscribes upper and lower edges of the elastomeric material.

16. A seal according to claim 4, wherein the anti-extrusion device comprises upper and lower end caps formed from metal or polymer materials.

17. A seal according to claim 4, wherein the elastomeric material has an outer portion that forms a largest diameter of the seal for sealing against other components.

18. A seal according to claim 4, wherein the elastomeric material comprises an o-ring or polypak.

19. A seal, comprising:
a elastomeric material having a low glass transition temperature (Tg) of at least −35° C. for high pressure, high temperature and low temperature sealing applications;
an anti-extrusion device mounted to the elastomeric material; wherein
a high temperature operating range is at least +177° C., and a low temperature operating range is at least −29° C.; and wherein
a high pressure operating range for the seal is no less than 15,000 psi.

20. A seal according to claim 19, wherein a high pressure operating range for the seal is no less than 20,000 psi.

21. A seal according to claim 19, wherein the elastomeric material is selected from the group consisting of hydrogenated acrylonitrile-butadiene (HNBR), acrylonitrile-butadiene (NBR), carboxylic-acrylonitrile-butadiene (XNBR), carboxylic-hydrogenated acrylonitrile-butadiene (XHNBR), copolymers of ethylene and polypropylene (EPM), terpolymer of ethylene, propylene and diene with a residual unsaturated portion of the diene in a side chain (EPDM), a fluorocarbon family of FKM, FEPM and FFKM, and combinations and blends of any these polymers to achieve a low Tg; and the elastomeric material further comprises:
a nanotechnology-enhanced polymer material comprising swcnt or mwcnt, carbon black, and at least a portion of the carbon black used in fabricating the seal is replaced with the nanotechnology-enhanced polymer material.

22. A seal according to claim 19, wherein the elastomeric material has a hardness of 85±5 Shore “A” that is cross-linked with peroxides, a minimum tensile strength of 1800 psi, a minimum ultimate elongation of 100%, a minimum tensile stress of 800 psi at 50% E, and 1500 psi at 100% E.

23. A seal according to claim 19, wherein the seal is formed in a continuous cylindrical shape with a flexible body formed from the elastomeric material, and the anti-extrusion device completely circumscribes upper and lower edges of the elastomeric material.

24. A seal according to claim 19, wherein the anti-extrusion device comprises upper and lower end caps formed from metal or polymer materials, and the elastomeric material comprises an o-ring or polypak.

25. A seal according to claim 19, wherein the elastomeric material has an outer portion that forms a largest diameter of the seal for sealing against other components.
